(19) United States
(12) Patent Application Publication
(10) Pub. No.: US 2014/0040496 A1
(43) Pub. Date: Feb. 6, 2014

(54) ON-DEMAND HTTP STREAM GENERATION

(71) Applicants: Praveen N. Moorthy, San Diego, CA (US); Ajay K. Luthra, San Diego, CA (US)

(72) Inventors: Praveen N. Moorthy, San Diego, CA (US); Ajay K. Luthra, San Diego, CA (US)

(73) Assignee: GENERAL INSTRUMENT CORPORATION, Horsham, PA (US)

(21) Appl. No.: 13/567,166

(22) Filed: Aug. 6, 2012

(51) Int. Cl. G06F 15/16

(52) U.S. Cl. 709/231

(57) ABSTRACT

In embodiments of on-demand HTTP stream generation, a manifest file (126) is published to a client device (108) for HTTP streaming of video content (124), and the manifest file identifies multiple video content streams each at a different bitrate and/or resolution. A request can be received from the client device for the video content at a first bitrate and/or resolution, segments (112) of the video content are generated at the first bitrate and/or resolution responsive to the request from the client device, and the segments of the video content are communicated to the client device. An additional request can be received from the client device for the video content at a second bitrate and/or resolution, subsequent segments of the video content are generated at the second bitrate and/or resolution responsive to the additional request from the client device, and the subsequent segments of the video content are communicated to the client device.

### TECHNICAL FIELD

This disclosure relates generally to the field of on-demand HTTP stream generation, and more specifically, to video content streams generated on-demand at a requested bitrate and/or resolution.

### BACKGROUND

The traditional notion of watching television at home has evolved into many different forms of viewing television content, on many different devices. For example, users can watch television content, such as live television, recorded television, and time-shifted programs and movies on various devices. Television viewing devices include televisions, display devices, entertainment devices, computers, and even mobile devices, such as tablets and mobile phones. Streaming video content over HTTP to a client device is a common technique that implements a one-to-one connection between a content server and a client device over a network.

The content server may generate multiple files of the same video content, each having a different bit rate. For example, three video content files with different bit rates may be commonly generated for HTTP Live Streaming (HLS), Dynamic Adaptive Streaming over HTTP (DASH), or other HTTP streaming video applications. A client device can then adaptively select the video content file with a bitrate that is most suitable for download based on network capacity. For example, a client device connects to a server over a network and downloads segments (also referred to as chunks) of the video content that are listed in a manifest file. Based on network throughput, the client device can download the content segments having a bitrate that accommodates the current network throughput. However, generating the multiple files of the same video content for distribution utilizes server hardware resources for video content streams that may not be requested for download to a client device, and also utilizes additional memory storage resources to store the unused video content streams at the different bitrates.

### BRIEF DESCRIPTION OF THE DRAWINGS

Embodiments of on-demand HTTP stream generation are described with reference to the following Figures. The same numbers may be used throughout to reference like features and components that are shown in the Figures:

FIG. 1 illustrates an example system in which embodiments of on-demand HTTP stream generation can be implemented.

FIGS. 2A-2C illustrate examples of video segments generated on-demand responsive to requests for video content at different bitrates and/or resolution in accordance with one or more embodiments.

FIG. 3 illustrates example method(s) of on-demand HTTP stream generation in accordance with one or more embodiments.

FIG. 4 illustrates various components of an example electronic device that can implement embodiments of on-demand HTTP stream generation.

### DETAILED DESCRIPTION

Embodiments of on-demand HTTP stream generation can be implemented to generate a video content stream on-demand at a requested bitrate and/or resolution, such as for HTTP download, HTTP Live Streaming (HLS), and/or Dynamic Adaptive Streaming over HTTP (DASH) to distribute the video content stream at the requested bitrate and/or resolution. As described above, generating multiple video content streams for distribution at different bitrates and/or resolutions unnecessarily utilizes server hardware and software resources for the video content streams at the different bitrates and/or resolutions that may not be requested for download to a client device. In embodiments of on-demand HTTP stream generation, segments of the requested video content are generated on-demand when the video content is requested by a client device at a specified bitrate and/or resolution, and can be implemented without modification to a client device, such as software downloads or updates. Generating the segments of the requested video content can include encoding, transcoding, packaging, and/or any other type of modifying the video content.

On-demand HTTP stream generation utilizes far less server hardware and software resources by only generating the requested video content streams on-demand. The multiple video content streams are listed in a manifest file that can be published to client devices, and the listed video content streams all reference to the same physical file of video content. This saves on memory storage resources that would otherwise be utilized to store all of the video content streams at the different bitrates and/or resolutions. In embodiments, the multiple video content streams that are listed in the manifest file at the different bitrates and/or resolutions are not generated until a client device requests the video content at a requested bitrate and/or resolution, and a video content stream is then generated on-demand from the video content.

For example, a client device can request video content at a first bitrate and/or resolution and the segments of the video content are generated (e.g., encoded or transcoded) for only the first bitrate and/or resolution. The client device can then request the video content at a second, different bitrate and/or resolution and the subsequent segments of the video content are generated for only the second bitrate and/or resolution. The client device can download the segments of the video content at the first bitrate and/or resolution and seamlessly switch to the subsequent segments of the video content at the second bitrate and/or resolution without interrupting playback of the video content at the client device.

While features and concepts of on-demand HTTP stream generation can be implemented in any number of different devices, systems, networks, and/or configurations, embodiments of on-demand HTTP stream generation are described in the context of the following example devices, systems, and methods.

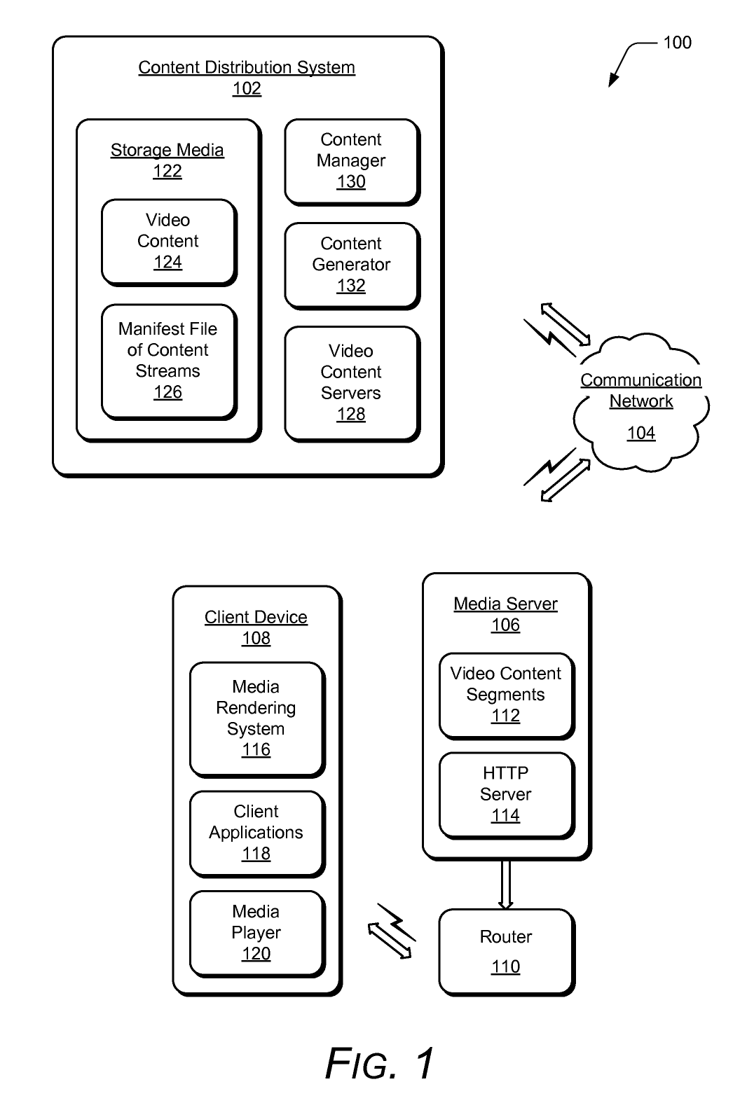

FIG. 1 illustrates an example system 100 in which embodiments of on-demand HTTP stream generation can be implemented. The example system 100 includes a content distribution system 102 that is implemented to deliver video content and data to any number of various devices via a communication network 104. The system 100 also includes an example of a media server 106 that can be implemented to receive the video content from the content distribution system and communicate the video content to one or more client devices 108 via a router 110, such as in a home or business environment.

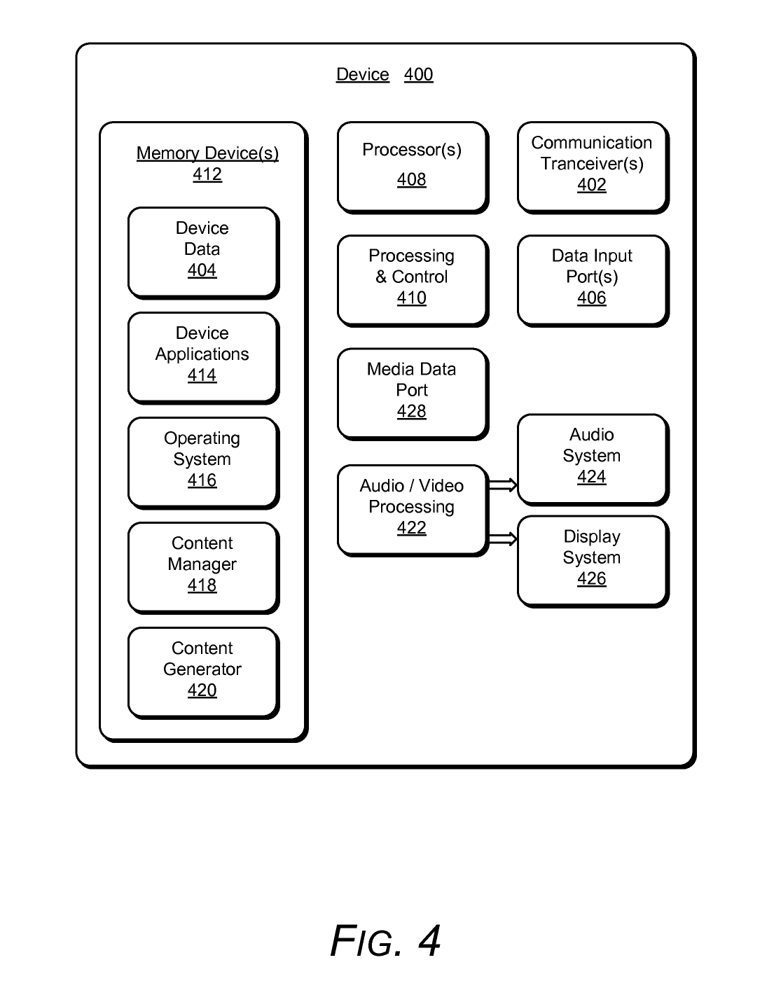

The media server 106 receives video content from the content distribution system 102 as video content segments 112 for distribution to the client device 108 with an HTTP server 114 via the router 110 that is implemented for wired and/or wireless communication. The media server 106 can be implemented with various components, such as a processor and memory devices, as well as with any combination of differing components as further described with reference to the example electronic device shown in FIG. 4. For example, the media server 106 may include memory to buffer the video content segments that are maintained for delivery to one or more client devices. Further, although shown as an independent component or device, the media server 106 may be implemented as an integrated component or device of a client device.

The example client device 108 may be implemented as any one or combination of a communication, computer, media playback, gaming, entertainment, and/or electronic device, such as a mobile phone or tablet device that can be configured as a television client device to receive and playback media content, such as video content. The client device can be implemented with various components, such as processor and memory devices, as well as with any combination of differing components as further described with reference to the example electronic device shown in FIG. 4. For example, the client device includes a media rendering system 116 to playback video content for viewing on an integrated display device. The client device can also include various client applications 118, such as a media player 120 that is implemented to manage playback of the video content and other media content at the client device.

Any of the servers and devices described herein can communicate via the communication network 104, which can be implemented to include a wired and/or a wireless network. The communication network can also be implemented using any type of network topology and/or communication protocol, and can be represented or otherwise implemented as a combination of two or more networks, to include IP-based networks and/or the Internet. The communication network may also include mobile operator networks that are managed by a mobile network operator and/or other network operators, such as a communication service provider, cell-phone provider, and/or Internet service provider.

The content distribution system 102 includes storage media 122 that may be any type of memory and/or suitable electronic data storage to store or otherwise maintain video content 124 and other data. The storage media maintains the video content 124 for distribution to client devices, such as to the client device 108, and includes a manifest file 126 that identifies multiple video content streams each at a different bitrate and/or resolution. The multiple video content streams that are listed in the manifest file all reference to the same physical file of the video content that is maintained by the storage media. In embodiments, the multiple video content streams that are listed in the manifest file at the different bitrates and/or resolutions are not generated until a client device requests the video content at a requested bitrate and/or resolution, and a video content stream is then generated on-demand from the video content. The content distribution system 102 also includes video content servers 128, such as servers for HTTP download, HTTP Live Streaming (HLS), and/or Dynamic Adaptive Streaming over HTTP (DASH) to distribute video content streams at requested bitrates and/or resolutions.

The video content 124 can include any type of audio, video, and/or image data in the form of television programming, movies, on-demand video, interactive games, advertisements, and the like. Further, the content distribution system can be implemented with various components, such as a processor and memory devices, as well as with any combination of differing components as further described with reference to the example electronic device shown in FIG. 4.

The content distribution system 102 also includes a content manager 130, and a content generator 132 (e.g., an encoder, transcoder, data packager, etc.), both of which can be implemented as computer-executable instructions, such as software applications, and executed by one or more processors to implement the various embodiments described herein. The content manager 130 manages the distribution of the video content 124 and other data to the client devices, and publishes the manifest file 126 to the client devices for HTTP streaming of the video content. In embodiments, the segments of the video content are generated on-demand at a bitrate and/or resolution that is associated with a video content stream listed in the manifest file 126, or similarly, the segments of the video content are generated responsive to any requested bitrate and/or resolution from the client device. The segments of the video content can be generated by encoding, transcoding, packaging, and/or any other type of modifying the video content.

The client device 108 can request a video content stream at a particular bitrate and/or resolution listed in the manifest file 126. In an implementation, the client device 108 can receive a top-level manifest file that lists URLs to each of the respective manifest files for the video content streams at the different bitrates and/or resolutions. The content distribution system 102 can publish the top-level manifest file with all of the different video content stream bitrates and resolutions that are supported by the content distribution system. When the client device 108 requests the manifest file that corresponds to a particular bitrate and/or resolution, the request for the manifest file at the particular bitrate and/or resolution can be utilized as an indication to implicitly change the bitrate and/or resolution that is represented by that manifest file. In an alternate implementation, the manifest file 126 can be published to the client device 108 for just one bitrate or resolution, and the manifest file provides the client device with an API that is outside of the HLS and DASH protocols. In this implementation, the client device can change the bitrate and/or resolution (either higher or lower) based on network and or processor loading conditions with an explicit API request, and the content distribution system switches to generate the video content stream at the requested bitrate and/or resolution corresponding to the request.

The content manager 130 can receive a request from the client device 108 for the video content 124 at a particular bitrate and/or resolution based on available bandwidth to download and/or playback the video content. The content generator 132 can then generate segments of the video content at the requested bitrate and/or resolution responsive to the request from the client device, and the segments of the video content are communicated to the client device. The content manager 130 can then receive an additional request from the client device for the video content 124 at a different bitrate and/or resolution, such as at a higher bitrate or a lower bitrate than first requested. The subsequent segments of the video content can then be generated on-demand at the different requested bitrate and/or resolution responsive to the additional request from the client device, and the subsequent segments of the video content are communicated to the client device. The client device can download the segments of the video content at the first bitrate and/or resolution and switch to the subsequent segments of the video content at the second bitrate and/or resolution without interrupting playback of the video content at the client device.

In alternate implementations, the content generator 132 at the content distribution system 102 generates a primary stream of the video content at the requested bitrate and/or resolution, and also generates a secondary stream of the video content at a lower bitrate and/or resolution. When the content manager 130 receives a request from the client device 108 for the video content at the lower bitrate or resolution, the content distribution system communicates a segment or partial segment of the secondary stream while the content generator 132 switches to the requested lower bitrate or resolution, after which point the segments will be sent from the primary stream.

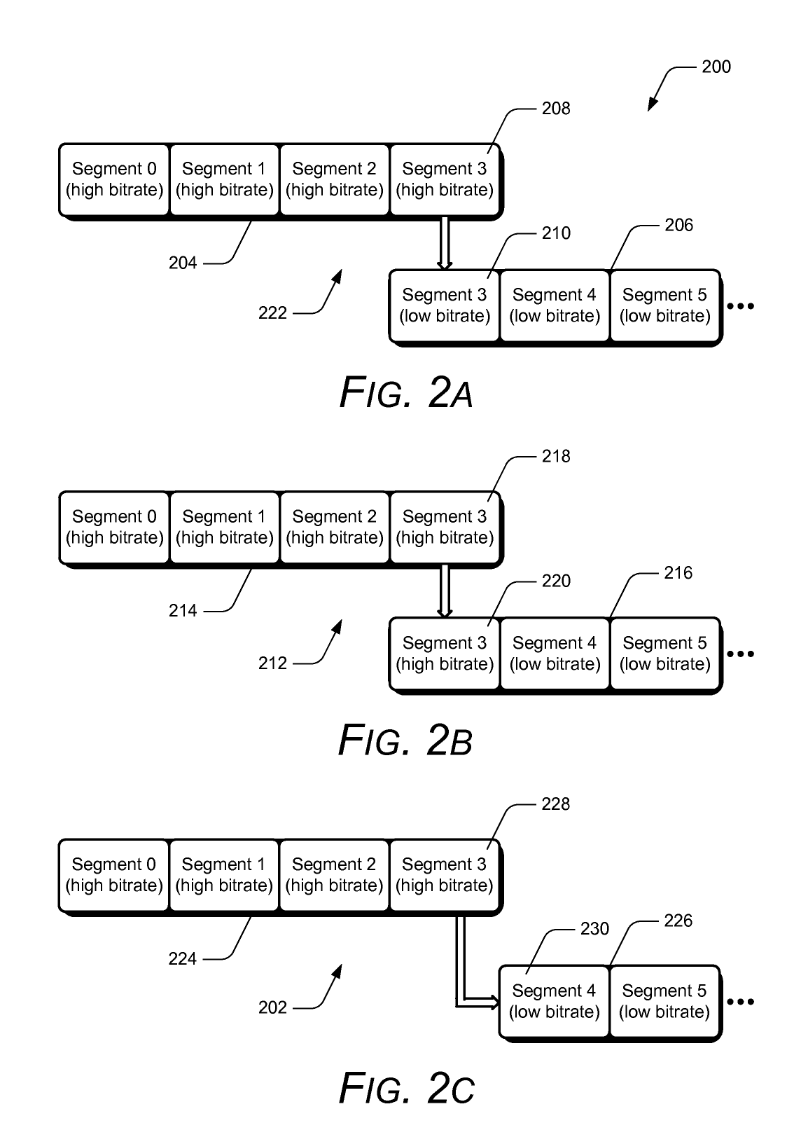

FIGS. 2A-2C illustrate examples 200 of video segments generated on-demand responsive to requests from a client device for video content at a requested bitrate and/or resolution and then at a different requested bitrate and/or resolution. The content manager 130 of the content distribution system 102, as described with reference to FIG. 1, can receive a request from the client device 108 (optionally, via the media server 106) for the video content 124 at a requested bitrate and/or resolution. The segments of the video content can be generated on-demand by the content generator 132 that encodes, transcodes, packages, and/or any other type of modifies the video content.

FIG. 2A illustrates at 202 that the content generator 132 can then generate initial segments 204 of the video content on-demand at the requested bitrate and/or resolution (e.g., a high bitrate in this example) responsive to the request from the client device, and the segments of the video content are communicated to the client device. This is represented as the initial segments 0-3 of the video content that are generated at the high bitrate. The content manager 130 can then receive an additional request from the client device for the video content 124 at a different bitrate and/or resolution (e.g., a low bitrate in this example). The subsequent segments 206 of the video content can then be generated on-demand at the different requested bitrate and/or resolution responsive to the additional request from the client device, and the subsequent segments of the video content are communicated to the client device. This is represented as the subsequent segments 3-5 of the video content that are generated at the low bitrate.

In this example shown at 202 (FIG. 2A), the last segment 208 of the video content that is generated at the first bitrate is also generated at the second bitrate and communicated to the client device 108 as the first subsequent segment 210 of the video content. This is represented as segment three (3) of the video content that is communicated to the client device as the last segment 208 at the high bitrate, and then segment three (3) of the video content is and again communicated to the client device as the first subsequent segment 210 of the video content at the low bitrate. The client device can then stitch together the last segment 208 of the video content and the first subsequent segment 210 of the video content for playback of the video content at the client device. Although the examples 200 shown in FIGS. 2A-2C indicate that bitrate and/or resolution changes occur at segment boundaries, it should be noted that the changes can also occur within a segment. For example, the last segment 208, which is represented as segment three (3) of the video content, may be generated partially at the higher bitrate and partially at the lower bitrate, and the lower bitrate portion is communicated to the client device. In implementations, the content generator may start generating a segment at a higher bitrate and/or resolution and then a request from a client device to change the bitrate and/or resolution is received.

FIG. 2B illustrates an alternate embodiment 212 in which the content generator 132 can generate the initial segments 214 of the video content on-demand at the requested bitrate and/or resolution (e.g., a high bitrate in this example) responsive to a request from the client device 108, and the segments of the video content are communicated to the client device. This is represented as the initial segments 0-3 of the video content that are generated at the high bitrate. The content manager 130 can then receive an additional request from the client device for the video content 124 at a different bitrate and/or resolution (e.g., a low bitrate in this example). The subsequent segments 216 of the video content can then be generated on-demand at the different requested bitrate and/or resolution responsive to the additional request from the client device, and the subsequent segments of the video content are communicated to the client device. This is represented as the subsequent segments 4-5 of the video content that are at the low bitrate.

In this example shown at 212 (FIG. 2B), the last segment 218 of the video content that is generated at the first bitrate is also communicated to the client device 108 again as the first subsequent segment 220 of the video content. This is represented as segment three (3) of the video content that is communicated to the client device as the last segment 218 at the high bitrate, and is then again communicated to the client device as the first subsequent segment 220 at the high bitrate. The client device can then stitch together the last segment 218 of the video content and the first subsequent segment 220 of the video content for playback of the video content at the client device.

FIG. 2C illustrates an alternate embodiment 222 in which the content generator 132 can generate the initial segments 224 of the video content on-demand at the requested bitrate and/or resolution (e.g., a high bitrate in this example) responsive to a request from the client device 108, and the segments of the video content are communicated to the client device. This is represented as the initial segments 0-3 of the video content that are generated at the high bitrate. The content manager 130 can then receive an additional request from the client device for the video content 124 at a different bitrate and/or resolution (e.g., a low bitrate in this example). The subsequent segments 226 of the video content can then be generated on-demand at the different requested bitrate and/or resolution responsive to the additional request from the client device, and the subsequent segments of the video content are communicated to the client device. This is represented as the subsequent segments 4-5 of the video content that are generated at the low bitrate. In this example shown at 222, the client device can stitch together the last segment 228 of the video content that is generated at the first bitrate and the first subsequent segment 230 of the video content that is generated at the second bitrate for playback of the video content at the client device.

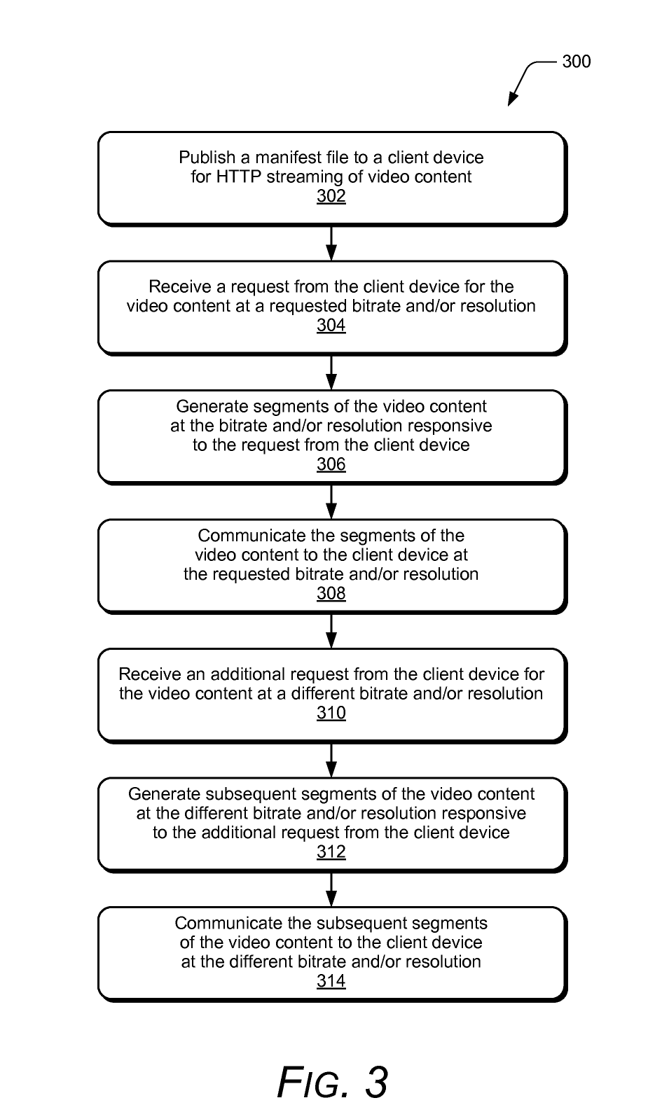

Example method 300 is described with reference to FIG. 3 in accordance with one or more embodiments of on-demand HTTP stream generation. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of on-demand HTTP stream generation. The order in which the method blocks are described are not intended to be construed as a limitation, and any number or combination of the described method blocks can be combined in any order to implement a method, or an alternate method.

At block 302, a manifest file is published to a client device for HTTP streaming of video content. For example, the content distribution system 102 (FIG. 1) includes the content manager 130 that publishes the manifest file 126 of video content streams to the client device 108 for HTTP streaming of the video content 124 to the client device. The manifest file 126 identifies multiple video content streams each at a different bitrate and/or resolution. The multiple video content streams that are listed in the manifest file all reference to the same physical file of the video content, and are not generated until a client device requests the video content at a requested bitrate and/or resolution. In implementations, the client device 108 receives a top-level manifest file that lists URLs to each of the respective manifest files for the video content streams at the different bitrates and/or resolutions. When the client device 108 requests the manifest file that corresponds to a particular bitrate and/or resolution, this request for the specific manifest file is utilized as an indication to implicitly change the bitrate and/or resolution that corresponds to the manifest file.

At block 304, a request is received from the client device for the video content at a requested bitrate and/or resolution. For example, the content manager 130 at the content distribution system 102 receives a request from the client device 108 (optionally, via the media server106) for the video content 124 at a requested bitrate and/or resolution that is published in the manifest file 126. In an implementation, the manifest file 126 is the top-level manifest file that lists the URLs to each of the respective manifest files for the video content streams at the different bitrates and/or resolutions.

At block 306, segments of the video content are generated at the bitrate and/or resolution responsive to the request from the client device. For example, the content generator 132 at the content distribution system 102 generates the segments 204 (FIG. 2) of the video content at the requested bitrate and/or resolution. In embodiments, the segments of the video content are generated on-demand at a bitrate and/or resolution that is associated with a video content stream listed in the manifest file 126, or similarly, the segments of the video content are generated for communication to the client device 108 responsive to any requested bitrate and/or resolution from the client device. The content generator 132 generates the segments of the video content by encoding, transcoding, packaging, and/or any other type of modifying the video content.

At block 308, the segments of the video content are communicated to the client device at the requested bitrate and/or resolution. For example, the video content servers 128 at the content distribution system 102 communicate the segments of the video content 124 to the client device 108 at the requested bitrate and/or resolution via the communication network 104, and optionally, via the media server 106. In embodiments, the video content servers 128 can be implemented for HTTP download, HTTP Live Streaming (HLS), and/or Dynamic Adaptive Streaming over HTTP (DASH) to distribute a video content stream at the requested bitrate and/or resolution. The video content is streamed to the client device from a video content server that communicates the video content to the client device as a single video content stream.

At block 310, an additional request is received from the client device for the video content at a different bitrate and/or resolution. For example, the content manager 130 at the content distribution system 102 receives an additional request from the same client device 108 for the video content 124 at a different bitrate and/or resolution that is published in the manifest file 126 (i.e., different than the requested bitrate or resolution at block 304).

At block 312, subsequent segments of the video content are generated at the different bitrate and/or resolution responsive to the additional request from the client device. For example, the content generator 132 at the content distribution system 102 generates the subsequent segments 206 of the video content on-demand at the different bitrate and/or resolution. The subsequent segments of the video content are generated at the different bitrate, which can be a higher bitrate or a lower bitrate than the segments of the video content that are generated at the initial bitrate. Alternatively or in addition, the subsequent segments of the video content are generated at the different resolution than the segments of the video content that are generated at the initial resolution.

At block 314, the subsequent segments of the video content are communicated to the client device at the different bitrate and/or resolution. For example, the video content servers 128 at the content distribution system 102 communicate the subsequent segments of the video content 124 to the client device 108 at the different bitrate and/or resolution. In embodiments, the last segment of the video content that is generated at the first bitrate and/or resolution is also generated at the second bitrate and/or resolution and communicated to the client device as the first subsequent segment of the video content. Alternatively, the last segment of the video content that is generated at the first bitrate and/or resolution is communicated to the client device again as the first subsequent segment of the video content. The client device then stitches together the last segment of the video content and the first subsequent segment of the video content for playback of the video content at the client device.

FIG. 4 illustrates various components of an example electronic device 400 that can be implemented as any device described with reference to any of the previous FIGS. 1-3. In embodiments, the electronic device may be implemented as the content distribution system 102, the media streamer 106, or the client device 108, such as described with reference to FIG. 1.

The electronic device 400 includes communication transceivers 402 that enable wired and/or wireless communication of device data 404, such as received data, data that is being received, data scheduled for broadcast, data packets of the data, etc. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers.

The electronic device400 may also include one or more data input ports 406 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones or cameras.

The electronic device 400 includes one or more processors 408 (e.g., any of microprocessors, controllers, and the like), or a processor and memory system, which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 410. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 400 also includes one or more memory devices 412 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 400 may also include a mass storage media device.

A memory device 412 provides data storage mechanisms to store the device data 404, other types of information and/or data, and various device applications 414 (e.g., software applications). For example, an operating system 416 can be maintained as software instructions with a memory device and executed by the processors 408. The device applications may also include a device manager, such as any form of a control application, software application, signal-processing and control module, code that is native to a particular device, a hardware abstraction layer for a particular device, and so on. The electronic device may also include a content manager 418 and a content generator 420, such as for a content distribution system, to implement embodiments of on-demand HTTP stream generation.

The electronic device 400 also includes an audio and/or video processing system 422 that processes audio data and/or passes through the audio and video data to an audio system 424 and/or to a display system 426. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 428. In implementations, the audio system and/or the display system are external components to the electronic device. Alternatively, the audio system and/or the display system are integrated components of the example electronic device.

Although embodiments of on-demand HTTP stream generation have been described in language specific to features and/or methods, the subject of the appended claims is not necessarily limited to the specific features or methods described. Rather, the specific features and methods are disclosed as example implementations of on-demand HTTP stream generation.

1. A method, comprising:
publishing a manifest file to a client device for HTTP streaming of video content, the manifest file identifying multiple video content streams each at a different bitrate and/or resolution;
receiving a request from the client device for the video content at a first bitrate published in the manifest file;
generating segments of the video content at the first bitrate responsive to the request from the client device;
communicating the segments of the video content to the client device at the first bitrate published in the manifest file;
receiving an additional request from the client device for the video content at a second bitrate published in the manifest file;
generating subsequent segments of the video content at the second bitrate responsive to the additional request from the client device; and
communicating the subsequent segments of the video content to the client device at the second bitrate.

2. The method as recited in claim 1, wherein the segments of the video content are generated for communication to the client device responsive to any requested bitrate and/or resolution from the client device.

3. The method as recited in claim 1, wherein the segments of the video content are generated on-demand at a bitrate and/or resolution that is associated with a video content stream listed in the manifest file.

4. The method as recited in claim 1, wherein the subsequent segments of the video content at the second bitrate are generated at a higher bitrate or a lower bitrate than the segments of the video content at the first bitrate.

5. The method as recited in claim 1, wherein the multiple video content streams that are listed in the manifest file all reference to the same physical file of the video content.

6. The method as recited in claim 1, further comprising:
communicating a last segment of the video content at the first bit rate as the first subsequent segment of the video content that is communicated to the client device.

7. The method as recited in claim 1, further comprising:
generating a last segment of the video content that is communicated to the client device at the first bit rate to the second bit rate; and
communicating the last segment of the video content that is generated at the second bit rate as the first subsequent segment of the video content to the client device that stitches together the last segment of video content and the first subsequent segment of the video content for playback of the video content at the client device.

8. A video content server system, comprising:
storage media configured to maintain video content for distribution to client devices;
a content manager configured to publish a manifest file for HTTP streaming of the video content to the client devices, the manifest file identifying multiple video content streams each at a different bitrate and/or resolution;
a server configured to communicate the video content to a client device at a requested bitrate and/or resolution;
content generator configured to:
generate segments of the video content at a first bitrate responsive to a request from the client device for the video content at the first bitrate; and
generate subsequent segments of the video content at a second bitrate responsive to an additional request from the client device for the video content at the second bitrate.

9. The video content server system as recited in claim 8, wherein the content generator is configured to generate the segments of the video content for communication to the client device responsive to any requested bitrate and/or resolution from the client device.

10. The video content server system as recited in claim 8, wherein the content generator is configured to generate the segments of the video content on-demand at a bitrate and/or resolution that is associated with a video content stream listed in the manifest file.

11. The video content server system as recited in claim 8, wherein the subsequent segments of the video content at the second bitrate are generated at a higher bitrate or a lower bitrate than the segments of the video content at the first bitrate.

12. The video content server system as recited in claim 8, wherein the multiple video content streams that are listed in the manifest file all reference to the same physical file of the video content that is maintained by the storage media.

13. The video content server system as recited in claim 8, wherein the server is configured to communicate a last segment of the video content at the first bitrate as the first subsequent segment of the video content that is communicated to the client device.

14. The video content server system as recited in claim 8, wherein:
the content generator is configured to generate a last segment of the video content that is communicated to the client device at the first bitrate to the second bitrate; and
the server is configured to communicate the last segment of the video content that is generated at the second bitrate as the first subsequent segment of the video content to the client device that stitches together the last segment of video content and the first subsequent segment of the video content for playback of the video content at the client device.

15. The video content server system as recited in claim 8, wherein the server is configured for HTTP streaming to communicate the video content to the client device as a single video content stream.

16. A method, comprising:
streaming video content to a client device in an HTTP streaming format, the video content listed in a manifest file that identifies multiple video content streams each at a different bitrate and/or resolution;
generating segments of a video content stream at a first bitrate responsive to a request for the video content at the first bitrate from the client device; and
generating subsequent segments of the video content stream at a second bitrate responsive to an additional request for the video content at the second bitrate from the client device.

17. The method as recited in claim 16, wherein:
the segments of the video content stream are generated on-demand at the first bitrate responsive to the request from the client device; and
the subsequent segments of the video content stream are generated on-demand at the second bitrate responsive to the additional request from the client device.

18. The method as recited in claim 16, wherein the video content is streamed to the client device in an HTTP streaming format from a server that communicates the video content to the client device as a single video content stream.

19. The method as recited in claim 16, wherein the multiple video content streams listed in the manifest file at the different bitrates and/or resolutions are not generated until the client device requests the video content at a requested bitrate and/or resolution.

20. The method as recited in claim 16, wherein the multiple video content streams listed in the manifest file at the different bitrates and/or resolutions are generated on-demand from a same physical file of the video content.
